(19) United States
(12) Patent Application Publication
(10) Pub. No.: US 2026/0270808 A1
(43) Pub. Date: Sep. 10, 2026

(54) ENHANCED FREQUENCY LAYER MEASUREMENTS

(71) Applicant: QUALCOMM Incorporated, San Diego, CA (US)

(72) Inventors: Qian ZHANG, Basking Ridge, NJ (US); Mostafa KHOSHNEVISAN, San Diego, CA (US); Tao LUO, San Diego, CA (US)

(21) Appl. No.: 19/547,380

(22) Filed: Feb. 23, 2026

Related U.S. Application Data
(60) Provisional application No. 63/766,817, filed on Mar. 4, 2025.

(51) Int. Cl. H04W 36/00; H04W 36/08; H04W 36/32; H04W 76/20

(52) U.S. Cl. CPC H04W 36/0058; H04W 36/08; H04W 36/322; H04W 76/20

(57) ABSTRACT

Methods, systems, and devices for wireless communications are described. A user equipment (UE) may receive control signaling that may indicate a frequency layer measurement configuration of a network entity, where the frequency layer measurement configuration may indicate at least one threshold associated with a first frequency layer for triggering measurement of a second frequency layer that is of higher priority than the first frequency layer. The UE may perform, based on a measurement of the first frequency layer satisfying the at least one threshold, one or more inter-frequency measurements of the second frequency layer, and may communicate one or more messages as part of a cell reselection procedure associated with the second frequency layer based on the one or more inter-frequency measurements.

### CROSS REFERENCE

This patent application claims the benefit of U.S. Provisional Patent Application No. 63/766,817 by ZHANG et al., entitled “ENHANCED FREQUENCY LAYER MEASUREMENTS,” filed Mar. 4, 2025, assigned to the assignee hereof, and expressly incorporated herein.

### FIELD OF TECHNOLOGY

The following relates to wireless communications, including enhanced frequency layer measurements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer, performing, based on a measurement of the first frequency layer satisfying the at least one threshold, one or more inter-frequency measurements of the second frequency layer, and communicating one or more messages as part of a cell reselection procedure associated with the second frequency layer based on the one or more inter-frequency measurements.

A UE for wireless communications is described. The UE may include one or more memories storing processor executable code, and one or more processors coupled with the one or more memories. The one or more processors may individually or collectively be operable to execute the code to cause the UE to receive control signaling that indicates a frequency layer measurement configuration of a network entity, where the frequency layer measurement configuration indicates at least one threshold associated with a first frequency layer for triggering measurement of a second frequency layer that is of higher priority than the first frequency layer, perform, based on a measurement of the first frequency layer satisfying the at least one threshold, one or more inter-frequency measurements of the second frequency layer, and communicate one or more messages as part of a cell reselection procedure associated with the second frequency layer based on the one or more inter-frequency measurements.

Another UE for wireless communications is described. The UE may include means for receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer, means for performing, based on a measurement of the first frequency layer satisfying the at least one threshold, one or more inter-frequency measurements of the second frequency layer, and means for communicating one or more messages as part of a cell reselection procedure associated with the second frequency layer based on the one or more inter-frequency measurements.

A non-transitory computer-readable medium storing code for wireless communications is described. The code may include instructions executable by one or more processors to receive control signaling that indicates a frequency layer measurement configuration of a network entity, where the frequency layer measurement configuration indicates at least one threshold associated with a first frequency layer for triggering measurement of a second frequency layer that is of higher priority than the first frequency layer, perform, based on a measurement of the first frequency layer satisfying the at least one threshold, one or more inter-frequency measurements of the second frequency layer, and communicate one or more messages as part of a cell reselection procedure associated with the second frequency layer based on the one or more inter-frequency measurements.

In some examples of the method, UEs, and non-transitory computer-readable medium described herein, the second frequency layer may be of higher priority than the first frequency layer based on the measurement of the first frequency layer satisfying the at least one threshold.

In some examples of the method, UEs, and non-transitory computer-readable medium described herein, receiving the control signaling may include operations, features, means, or instructions for receiving the control signaling indicating the frequency layer measurement configuration that identifies a set of multiple thresholds associated with a set of multiple priorities for a set of multiple frequency layers, where a priority of the set of multiple priorities for the second frequency layer of the set of multiple frequency layers may be based on the measurement of the first frequency layer of the set of multiple frequency layers being within a range of values defined by a first threshold and a second threshold of the set of multiple thresholds.

In some examples of the method, UEs, and non-transitory computer-readable medium described herein, the control signaling indicates a set of multiple frequency layer measurement configurations associated with a set of multiple frequency layers and the frequency layer measurement configuration may be associated with the first frequency layer.

In some examples of the method, UEs, and non-transitory computer-readable medium described herein, the frequency layer measurement configuration indicates that the at least one threshold corresponds to a bound value for a signal metric and the frequency layer measurement configuration indicates to measure one or more frequency layers different than the first frequency layer based on the measurement of the first frequency layer satisfying the bound value.

In some examples of the method, UEs, and non-transitory computer-readable medium described herein, the one or more frequency layers may be of higher priority than the first frequency layer.

In some examples of the method, UEs, and non-transitory computer-readable medium described herein, the frequency layer measurement configuration indicates to measure one or more second frequency layers different than the first frequency layer based on the measurement of the first frequency layer failing to satisfy a second bound value.

In some examples of the method, UEs, and non-transitory computer-readable medium described herein, the at least one threshold includes a first threshold and a second threshold that define a range of values and the one or more inter-frequency measurements of the second frequency layer may be performed based on the measurement of the first frequency layer being within the range of values.

In some examples of the method, UEs, and non-transitory computer-readable medium described herein, the one or more messages may be communicated as part of the cell reselection procedure based on at least one of the one or more inter-frequency measurements of the second frequency layer satisfying a cell reselection procedure threshold.

In some examples of the method, UEs, and non-transitory computer-readable medium described herein, the frequency layer measurement configuration indicates location information associated with a coverage area of the second frequency layer and the one or more inter-frequency measurements of the second frequency layer may be performed based on the UE being located within the coverage area.

In some examples of the method, UEs, and non-transitory computer-readable medium described herein, the location information indicates that the coverage area of the second frequency layer may be co-located with a coverage area of the first frequency layer.

In some examples of the method, UEs, and non-transitory computer-readable medium described herein, the location information indicates a threshold distance between the coverage area of the second frequency layer and a coverage area of the first frequency layer.

In some examples of the method, UEs, and non-transitory computer-readable medium described herein, the one or more inter-frequency measurements include a reference signal received power (RSRP), a reference signal received quality (RSRQ), or both.

In some examples of the method, UEs, and non-transitory computer-readable medium described herein, the measurement of the first frequency layer includes a RSRP, a RSRQ, or both.

In some examples of the method, UEs, and non-transitory computer-readable medium described herein, receiving the control signaling may include operations, features, means, or instructions for receiving a system information block (SIB) or a radio resource control (RRC) message indicating the frequency layer measurement configuration.

In some examples of the method, UEs, and non-transitory computer-readable medium described herein, the first frequency layer may be associated with a serving cell for the UE or a non-serving cell for the UE.

A method for wireless communications by a network entity is described. The method may include outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer and communicating one or more messages as part of a cell reselection procedure associated with the second frequency layer based on the control signaling.

A network entity for wireless communications is described. The network entity may include one or more memories storing processor executable code, and one or more processors coupled with the one or more memories. The one or more processors may individually or collectively be operable to execute the code to cause the network entity to output control signaling that indicates a frequency layer measurement configuration of the network entity, where the frequency layer measurement configuration indicates at least one threshold associated with a first frequency layer for triggering measurement of a second frequency layer that is of higher priority than the first frequency layer and communicate one or more messages as part of a cell reselection procedure associated with the second frequency layer based on the control signaling.

Another network entity for wireless communications is described. The network entity may include means for outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer and means for communicating one or more messages as part of a cell reselection procedure associated with the second frequency layer based on the control signaling.

A non-transitory computer-readable medium storing code for wireless communications is described. The code may include instructions executable by one or more processors to output control signaling that indicates a frequency layer measurement configuration of the network entity, where the frequency layer measurement configuration indicates at least one threshold associated with a first frequency layer for triggering measurement of a second frequency layer that is of higher priority than the first frequency layer and communicate one or more messages as part of a cell reselection procedure associated with the second frequency layer based on the control signaling.

In some examples of the method, network entities, and non-transitory computer-readable medium described herein, outputting the control signaling may include operations, features, means, or instructions for outputting the control signaling indicating the frequency layer measurement configuration that identifies a set of multiple thresholds associated with a set of multiple priorities for a set of multiple frequency layers.

In some examples of the method, network entities, and non-transitory computer-readable medium described herein, the control signaling indicates a set of multiple frequency layer measurement configurations associated with a set of multiple frequency layers and the frequency layer measurement configuration may be associated with the first frequency layer.

In some examples of the method, network entities, and non-transitory computer-readable medium described herein, the frequency layer measurement configuration indicates that the at least one threshold corresponds to a bound value for a signal metric and the frequency layer measurement configuration indicates to measure one or more frequency layers different than the first frequency layer based on a measurement of the first frequency layer satisfying the bound value.

In some examples of the method, network entities, and non-transitory computer-readable medium described herein, the one or more frequency layers may be of higher priority than the first frequency layer.

In some examples of the method, network entities, and non-transitory computer-readable medium described herein, the frequency layer measurement configuration indicates to measure one or more second frequency layers different than the first frequency layer based on the measurement of the first frequency layer failing to satisfy a second bound value.

In some examples of the method, network entities, and non-transitory computer-readable medium described herein, the at least one threshold includes a first threshold and a second threshold that define a range of values.

In some examples of the method, network entities, and non-transitory computer-readable medium described herein, the frequency layer measurement configuration indicates location information associated with a coverage area of the second frequency layer.

In some examples of the method, network entities, and non-transitory computer-readable medium described herein, the location information indicates that the coverage area of the second frequency layer may be co-located with a coverage area of the first frequency layer.

In some examples of the method, network entities, and non-transitory computer-readable medium described herein, the location information indicates a threshold distance between the coverage area of the second frequency layer and a coverage area of the first frequency layer.

In some examples of the method, network entities, and non-transitory computer-readable medium described herein, the network entity includes a first network entity and a second network entity and the control signaling may be output via the first network entity and the one or more messages may be communicated via the second network entity.

In some examples of the method, network entities, and non-transitory computer-readable medium described herein, outputting the control signaling may include operations, features, means, or instructions for outputting a SIB or an RRC message indicating the frequency layer measurement configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support enhanced frequency layer measurements in accordance with one or more aspects of the present disclosure.

FIGS. 3A and 3B show examples of coverage diagrams that support enhanced frequency layer measurements in accordance with one or more aspects of the present disclosure.

FIG. 4 shows an example of a process flow that supports enhanced frequency layer measurements in accordance with one or more aspects of the present disclosure.

FIGS. 5 and 6 show block diagrams of devices that support enhanced frequency layer measurements in accordance with one or more aspects of the present disclosure.

FIG. 7 shows a block diagram of a communications manager that supports enhanced frequency layer measurements in accordance with one or more aspects of the present disclosure.

FIG. 8 shows a diagram of a system including a device that supports enhanced frequency layer measurements in accordance with one or more aspects of the present disclosure.

FIGS. 9 and 10 show block diagrams of devices that support enhanced frequency layer measurements in accordance with one or more aspects of the present disclosure.

FIG. 11 shows a block diagram of a communications manager that supports enhanced frequency layer measurements in accordance with one or more aspects of the present disclosure.

FIG. 12 shows a diagram of a system including a device that supports enhanced frequency layer measurements in accordance with one or more aspects of the present disclosure.

FIGS. 13 and 14 show flowcharts illustrating methods that support enhanced frequency layer measurements in accordance with one or more aspects of the present disclosure.

### DETAILED DESCRIPTION

In some wireless communications systems, a UE may perform measurements on nearby cells to facilitate cell reselection. For example, the UE may perform inter-frequency measurements to determine whether to select a new frequency layer in which to operate. In some cases, the frequency layers may be associated with priorities, and the inter-frequency measurements may be triggered at the UE based on the priorities. For example, the UE may operate on a first frequency layer. The UE may determine that a priority of a first frequency layer associated with a serving cell for the UE is lower than a priority of a second frequency layer, and the UE may perform inter-frequency measurements on the second frequency layer (e.g., reference signal received power (RSRP), reference signal received quality (RSRQ) measurements) to determine whether to move from the first frequency layer to the second frequency layer. In some cases, however, the UE may not be within a coverage area of the second frequency layer, and may waste power, time, and resources attempting to perform the inter-frequency measurements on the second frequency layer. For example, a network entity may be associated with three different frequency layers, which may each have a different coverage area. The first frequency layer may have a large coverage area, which may include portions that do not overlap with the second frequency layer. The first frequency layer may be of a lower priority than the second frequency layer. If the UE is not within the overlapping coverage area, the UE may perform the inter-frequency measurements on the second frequency layer, even if the UE may not be within the coverage area of the second frequency layer.

The techniques described herein support a network entity indicating frequency layer measurement configurations for a UE to determine whether to perform inter-frequency measurements of higher priority frequency layers based on thresholds associated with the RSRP, RSRQ, or both of a first frequency layer (e.g., a current frequency layer, serving cell, camped cell). For example, in some cases, a high RSRP measured in the first frequency layer may indicate that the UE is closer to the network entity and thus more likely to be within the coverage area of other frequency layers, such as a second frequency layer. In some implementations, the priorities of the frequency layers may be determined based on the RSRP, RSRQ, or both of the first frequency layer. For example, if the RSRP of the first frequency layer exceeds a threshold, the priority of the second frequency layer may be indicated to be higher than a priority of the first frequency layer, and the UE may perform inter-frequency measurements on the second frequency layer. If the RSRP of the first frequency layer does not exceed the threshold, then the priority of the first frequency layer may be indicated to be higher than the priority of the second frequency layer and the UE may not perform inter-frequency measurements on the second frequency layer. In some examples, the network entity may configure the thresholds based on the known coverage areas of the frequency layers. In other implementations, the inter-frequency measurements of the second frequency layer may be performed if the RSRP, RSRQ, or both of the first frequency layer exceed a threshold (e.g., upper bound) and the priority of the second frequency layer is greater than the priority of the first frequency layer. For example, the inter-frequency measurements of the second frequency layer may be based on the measurements of the first frequency layer exceeding a threshold, as well as the priority of the second frequency layer being greater than the priority of the first frequency layer.

Aspects of the disclosure are initially described in the context of wireless communications systems, coverage diagrams, and process flows. Aspects of the disclosure are further illustrated by and described herein with reference to apparatus diagrams, system diagrams, and flowcharts that relate to enhanced frequency layer measurements.

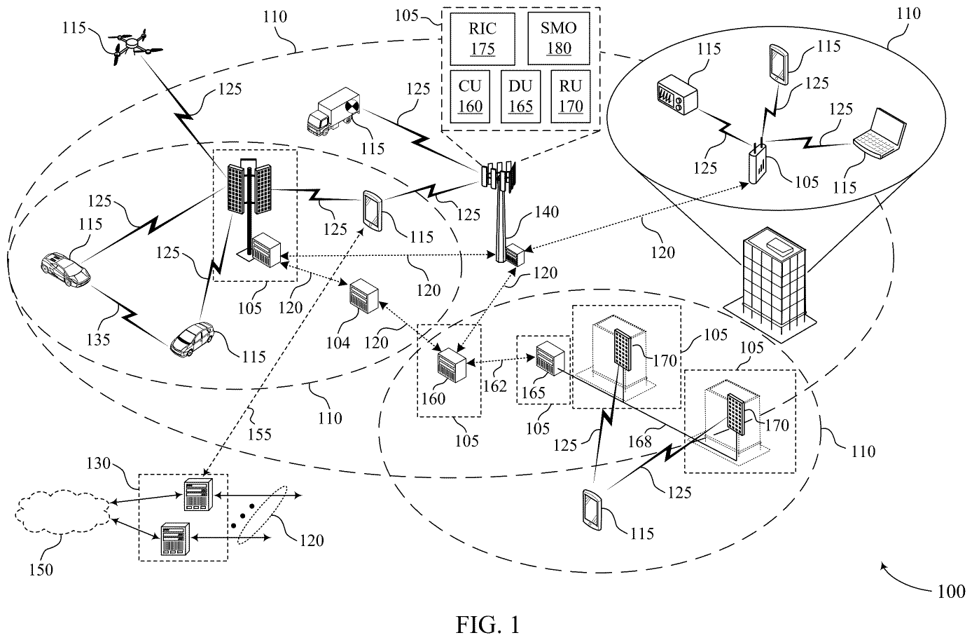

FIG. 1 shows an example of a wireless communications system 100 that supports enhanced frequency layer measurements in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (VIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support enhanced frequency layer measurements as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, a UE 115 may perform measurements on nearby cells to facilitate cell reselection. For example, the UE 115 may perform inter-frequency measurements to determine whether to select a new frequency layer in which to operate. In some cases, the frequency layers may be associated with priorities, and the inter-frequency measurements may be triggered at the UE 115 based on the priorities. For example, the UE 115 may operate on a first frequency layer. The UE 115 may determine that a priority of a first frequency layer associated with a serving cell for the UE 115 is lower than a priority of a second frequency layer, and the UE 115 may perform inter-frequency measurements on the second frequency layer (e.g., reference signal received power (RSRP), reference signal received quality (RSRQ) measurements) to determine whether to move from the first frequency layer to the second frequency layer. In some cases, however, the UE 115 may not be within a coverage area of the second frequency layer, and may waste power, time, and resources attempting to perform the inter-frequency measurements on the second frequency layer. For example, a network entity 105 may be associated with three different frequency layers, which may each have a different coverage area. The first frequency layer may have a large coverage area, which may include portions that do not overlap with the second frequency layer. The first frequency layer may be of a lower priority than the second frequency layer. If the UE 115 is not within the overlapping coverage area, the UE 115 may perform the inter-frequency measurements on the second frequency layer, even if the UE 115 may not be within the coverage area of the second frequency layer.

The techniques described herein support a network entity 105 indicating frequency layer measurement configurations for a UE 115 to determine whether to perform inter-frequency measurements of higher priority frequency layers based on thresholds associated with the RSRP, RSRQ, or both of a first frequency layer (e.g., a current frequency layer, serving cell, camped cell). For example, in some cases, a high RSRP measured in the first frequency layer may indicate that the UE 115 may be closer to the network entity 105 and thus more likely to be within the coverage area of other frequency layers, such as a second frequency layer. In some implementations, the priorities of the frequency layers may be determined based on the RSRP, RSRQ, or both of the first frequency layer. For example, if the RSRP of the first frequency layer exceeds a threshold, the priority of the second frequency layer may be indicated to be higher than a priority of the first frequency layer, and the UE 115 may perform inter-frequency measurements on the second frequency layer. If the RSRP of the first frequency layer does not exceed the threshold, then the priority of the first frequency layer may be indicated to be higher than the priority of the second frequency layer and the UE 115 may not perform inter-frequency measurements on the second frequency layer. In some examples, the network entity 105 may configure the thresholds based on the known coverage areas of the frequency layers. In other implementations, the inter-frequency measurements of the second frequency layer may be performed if the RSRP, RSRQ, or both of the first frequency layer exceed a threshold (e.g., upper bound) and the priority of the second frequency layer is greater than the priority of the first frequency layer. For example, the UE 115 may perform the inter-frequency measurements of the second frequency layer based on the measurements of the first frequency layer exceeding a threshold, as well as the priority of the second frequency layer being greater than the priority of the first frequency layer.

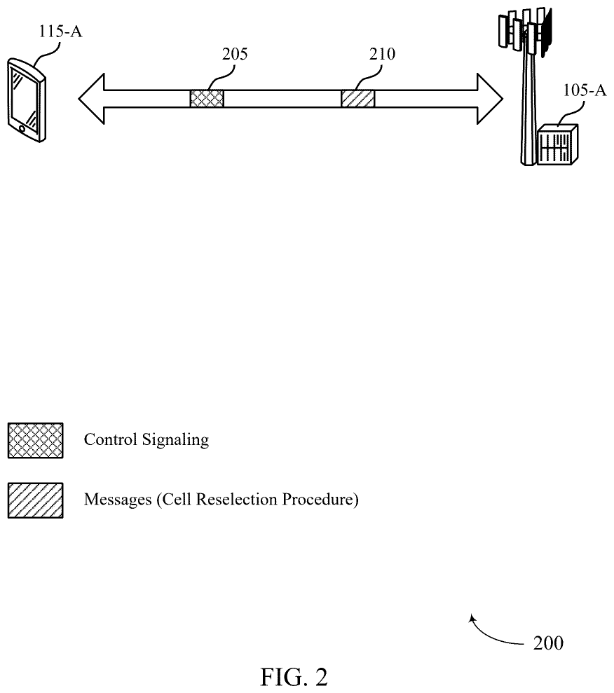

FIG. 2 shows an example of a wireless communications system 200 that supports enhanced frequency layer measurements in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-A and the UE 115-A, which may be examples of corresponding devices as described herein, including with reference to FIG. 1. The techniques described herein in the context of the wireless communications system 200 may support the UE 115-A determining when to perform inter-frequency measurements based on control signaling 205 from the network entity 105-A.

In some wireless communication systems 200, a UE 115-A may perform measurements on nearby cells to facilitate cell reselection. For example, the UE 115-A may perform inter-frequency measurements to determine whether to select a new frequency layer in which to operate. In some implementations, the frequency layers may be associated with priorities, and the inter-frequency measurements may be triggered at the UE 115-A based on the priorities.

In some cases, a network entity 105-A may configure or indicate the priorities of the frequency layers for cell reselection to the UE 115-B, such as via control signaling 205. In some examples, the control signaling 205 may include radio resource control (RRC) messages. For example, the network entity 105-B may output a message (e.g., a RRC release message) to configure the UE 115-A for cell reselection.

For example, if the UE 115-A moves into an idle or inactive state, the network entity 105-A may output an RRC release message indicating a configuration for cell reselection at the UE 115-A for a next time period that the UE 115-A may reselect a cell. The RRC release message may include or indicate parameters related to configuring cell reselection priorities, such as inter-frequency layer priorities (e.g., cellReselectionPriorities, freqPriorityListNR, cellReselectionPriority, cellReselectionSubPriority). In other examples, the control signaling 205 may include broadcasted system information. For example, the network entity 105-A may broadcast system information (e.g., system information block (SIB)) to a UE 115-A that may be camped on a serving cell, such as via specific SIBs (e.g., SIB2, SIB4 (for inter-frequency cell reselection)). The broadcasted system information may be cell common control signaling 205, while the RRC release message may be UE-specific control signaling 205. The RRC release message may include or indicate parameters related to configuring cell reselection priorities, such as inter-frequency layer priorities (e.g., cellReselectionPriority, cellReselectionSubPriority).

In some implementations, the UE 115-A may perform cell reselection procedures based on some triggers or conditions being satisfied. For example, a cell selection criterion, S, may be satisfied when Srxlev>0 and Squal>0, where Srxlev may be associated with a RSRP of a measured cell, as in Equation 1:

$$Srxlev = {Q}_{rxlevmeas} - {Q}_{rxlevmin} - {P}_{compensation} > 0 ( dB ) \qquad ( 1 )$$

Qᵣₓₗₑᵥₘₑₐₛ may be the RSRP of the measured cell, and Qᵣₓₗₑᵥₘᵢₙ may be a minimum RSRP for the measured cell. P_{compensation} may be a power compensation parameter. For FR2, P_{compensation} may be 0. For FR1, P_{compensation}=max (P_{EMAX1}−P_{powerClass}, 0) or, if the UE 115-A supports configuration of a parameter for additional power (e.g., additionalPmax), P_{compensation}=max (P_{EMAX1}−P_{powerClass}, 0)−(min(P_{EMAX2}, P_{powerClass})−min (P_{EMAX1}, P_{powerClass})). P_{EMAX1} and P_{EMAX2} may be the maximum transmission power level that the UE 115-A may use when transmitting in the cell, and may be indicated or configured in control signaling 205. P_{powerClass} may be the maximum radio frequency (RF) output power of the UE 115-A according to the power class of the UE 115-A. In some examples, Qᵣₓₗₑᵥₘₑₐₛ−Qᵣₓₗₑᵥₘᵢₙ may be related to a downlink and P_{compensation} may be related to an uplink.

Squal may be associated with an RSRQ of the serving cell, as in Equation 2:

$$Srxlev = {Q}_{qualmeas} - {Q}_{qualmin} > 0 ( dB ) \qquad ( 2 )$$

Q_{qualmeas} may be the RSRQ of the measured cell, while Q_{qualmin} may be a minimum RSRQ for the measured cell.

In some cases, for inter-frequency cell reselection or inter-radio access technology (RAT) cell reselection, measurements may be performed outside of a serving cell based on some conditions associated with the priority of frequency layers. In some examples, if a frequency layer (or RAT) different from the serving cell is of a higher priority than the current frequency layer (e.g., camped cell, current frequency layer, current RAT, serving cell), the UE 115-A may perform inter-frequency measurements. If the frequency layer different from the serving cell is of equal or lower priority than the current frequency layer, the UE 115-A may not perform inter-frequency measurements as long as Srxlev and Squal for the serving cell are larger than a configured threshold. For example, if the serving cell fulfills Srxlev>S_{nonIntraSearchP} and Squal>S_{nonIntraSearchQ}, where S_{nonIntraSearchP} and S_{nonIntraSearchQ} are thresholds for Squal and Srxlev, respectively, the UE 115-A may not to perform inter-frequency measurements of inter-frequency cells of equal or lower priority, or of inter-RAT frequency cells of lower priority.

In some cases, if the UE 115-A performs inter-frequency or inter-RAT measurements, which may be triggered by the conditions described herein, the UE 115-A may perform cell reselection (e.g., via messages 210) and switch cells based on some conditions associated with the cell selection criterion, S, being satisfied. For example, in the case of frequency layers of higher priority than the current frequency layer, the UE 115-A may reselect the higher priority frequency layer if the Srxlev, Squal, or both of the higher priority frequency layer (or RAT) exceeds a configured threshold. In the case of frequency layers of lower priority than the current frequency layer, the UE 115-A may reselect the frequency layer (or RAT) of the lower priority frequency layer if the Srxlev, Squal, or both of the lower priority frequency layer exceeds a configured threshold and the Srxlev, Squal, or both of the serving cell fails to satisfy a configured threshold.

In some implementations, based on the conditions for inter-frequency measurements for cell reselection, the UE 115-A may attempt to measure higher priority frequency layers, while camping on a lower priority frequency layer, even if the UE 115-A may not select the lower priority frequency layer. For example, the UE 115-A may be in the coverage area of a frequency layer for the network entity 105-A that may be a lower priority, but may have a larger coverage area (e.g., n71) than other frequency layers associated with the network entity 105-A (e.g., n41, n25). The UE 115-A may be in a portion of the coverage area for the frequency layer that may not overlap with the coverage area for the other frequency layers. However, because the other frequency layers are of higher priority, the UE 115-A may attempt to perform inter-frequency measurements on the other frequency layers. That is, the UE 115-A may perform an unnecessary reselection attempt on the other frequency layers. For example, the priority of a first frequency layer that the UE 115-A may be camped on (e.g., n71) may be 3, while the value of a second frequency layer (e.g., n25) may be 7.2 and a third frequency layer (n41) may have a priority of 7.6. Further, the frequency layers may include multiple bands. For example, the third frequency layer may include two bands of (e.g., 501390(n41)-273RB, 521310(n41)-217RB) that may both be of priority 7.6. The UE 115-A may not be located in the coverage area of the second frequency layer, the third frequency layer, or both, and may waste resources measuring them based on the priorities associated with the second frequency layer and the third frequency layer exceeding the priority of the first frequency layer.

In some implementations, in order to avoid unnecessary reselection attempts, it may be beneficial to consider the RSRP of the current frequency layer (e.g., serving cell, camped cell) before performing inter-frequency measurements. For example, a high RSRP at the first frequency layer may indicate that the UE 115-A may be closer to the network entity 105-A and thus more likely to be within the coverage area of other frequency layers. Additionally, or alternatively, one or more rules or one or more adaptive frequency layer prioritization schemes may be implemented to avoid unnecessary reselection attempts. For example, in some cases, the priorities of the frequency layers may be determined based on the RSRP, RSRQ, or both of the first frequency layer. For example, if the RSRP of the first frequency layer exceeds a threshold, the priority of the second frequency layer may be indicated to be higher than a priority of the first frequency layer, and the UE 115-A may perform inter-frequency measurements on the second frequency layer. If the RSRP of the first frequency layer does not exceed the threshold, then the priority of the first frequency layer may be indicated to be higher than the priority of the second frequency layer and the UE 115-A may not perform inter-frequency measurements on the second frequency layer. In other cases, the inter-frequency measurements of the second frequency layer may only be performed if the RSRP, RSRQ, or both of the first frequency layer exceed a threshold and the priority of the second frequency layer is greater than the priority of the first frequency layer.

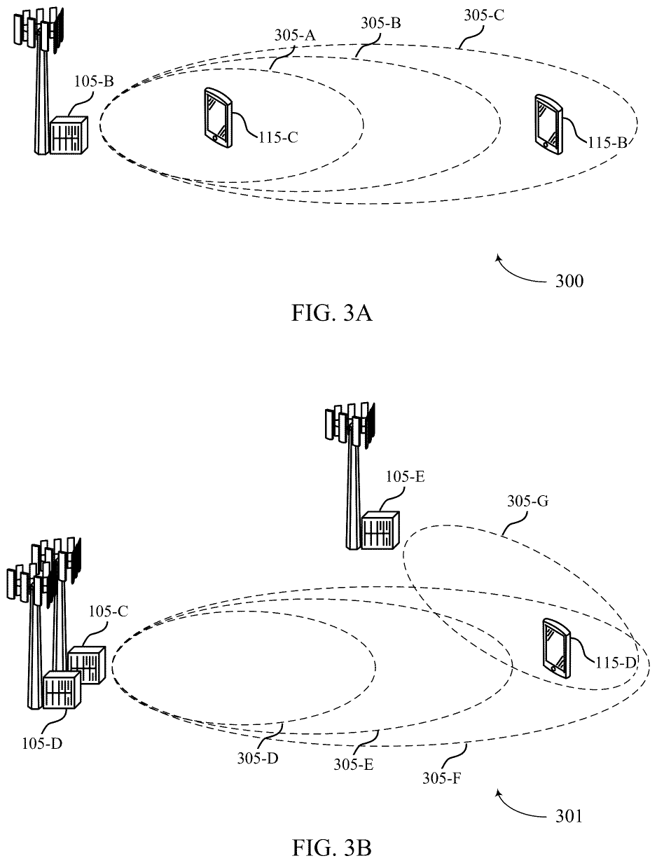

FIGS. 3A and 3B show examples of coverage diagrams 300 and 301 that supports enhanced frequency layer measurements in accordance with one or more aspects of the present disclosure. The coverage diagrams 300 and 301 may implement, or be implemented by, aspects of the wireless communications systems 100 and 200. For example, the coverage diagrams 300 and 301 may include one or more network entities 105 and UEs 115, including at least the network entities 105-B, 105-C, 105-D, and 105-E, and the UEs 115-B, 115-C, and 115-D, which may be examples of corresponding devices as described herein, including with reference to FIGS. 1 and 2. The techniques described herein in the context of the coverage diagrams 300 and 301 may support a network entity 105 to indicate configurations for the UEs 115 to use for determining to perform inter-frequency measurements on high priority frequency layers 305.

With respect to coverage diagram 300, a network entity 105-B may output or provide multiple frequency layers 305, such as frequency layers 305-A, 305-B, and 305-C. In some cases, frequency layer 305-A may be of high priority, but have a small coverage area, while frequency layer 305-C may be of low priority but have a large coverage area. The UE 115-B and the UE 115-C may operate via the frequency layer 305-C, or may have recently used the frequency layer 305-C (e.g., idle or inactive UE 115). The UE 115-C may identify that frequency layers 305-A and 305-B are of higher priority than frequency layer 305-C, and may perform inter-frequency measurements on the frequency layers 305-A and 305-B. The UE 115-C may be within the coverage area of all three frequency layers 305, and so may reselect a frequency layer 305 based on the inter-frequency measurements. In some examples, UE 115-B may also identify that the frequency layers 305-A and 305-B may be of higher priority than the frequency layer 305-C. The UE 115-B may attempt to perform inter-frequency measurements on the frequency layers 305-A and 305-B, but may be unsuccessful, as the UE 115-B may not be within the coverage area of the frequency layers 305-A and 305-B.

In some implementations, the network entity 105-B may configure frequency layer priorities to be conditioned on the RSRP, RSRQ, or both at the current frequency layer (e.g., camping frequency layer, serving cell). For example, UEs 115-B and 115-C may be camped on frequency layer 305-C. However, UE 115-C may be closer to the network entity 105-B. The UEs 115 may perform measurements on the frequency layer 305-C. In some examples, the RSRP, RSRQ, or both measured at the UE 115-C may be greater than the RSRP, RSRQ, or both measured by the UE 115-B. This may reflect that the UE 115-C closer to the network entity 105-B than the UE 115-B, and may also indicate that the UE 115-C may be more likely to be within the coverage area of the frequency layer 305-C and the frequency layer 305-B.

In some cases, the network entity 105-B may configure or indicate a configuration to the UEs 115 that may include one or more thresholds associated with the measurements of the frequency layer 305-C, as well as associated priorities for the frequency layers 305 based on the one or more thresholds. That is, the network entity 105-B may configure priorities for the frequency layers 305, which may be associated with one or more thresholds that the network entity 105-B may also configure, such that the priority of each frequency layer 305 may be based on a measured value of the frequency layer 305-C compared to the configured one or more thresholds. For example, an RSRP above a first threshold may indicate a high priority for frequency layer 305-A, a medium priority for frequency layer 305-B, and a low priority for frequency layer 305-C, and the UE 115, such as the UE 115-C, may perform inter-frequency measurements on the frequency layers 305-A or 305-B. An RSRP below the first threshold but above a second threshold may indicate a medium priority for frequency layer 305-A, a high priority for frequency layer 305-B, and a medium or low priority for frequency layer 305-C. In this case, the UE 115 may not perform inter-frequency measurements on the frequency layer 305-A, but may perform inter-frequency measurements on the frequency layer 305-B. An RSRP below the second threshold may indicate a high priority for frequency layer 305-C and a low priority for the frequency layers 305-A and 305-B. In this case, the UE 115, such as the UE 115-B, may not perform inter-frequency measurements on the frequency layers 305-A or 305-B. Table 1 may be an example of how RSRP of the frequency layer 305-C for the UEs 115 may be associated with the priorities of the frequency layers 305.

TABLE 1
Example of an Association between RSRP Thresholds
and Priorities of Frequency Layers 305 for a
UE 115 Camped in the Frequency Layer 305-C.

| RSRP of | Priority of | Priority of | Priority of |
|---|---|---|---|
| Frequency | Frequency Layer | Frequency Layer | Frequency Layer |
| Layer 305-C | 305-A | 305-B | 305-C |
| RSRP > | 7.6 | 7.2 | 3 |
| Threshold 1 | | | |
| Threshold 1 ≥ | 6 | 7 | 5 |
| RSRP > | | | |
| Threshold 2 | | | |
| Threshold 2 ≥ | 5 | 7 | 7 |
| RSRP > | | | |
| Threshold 3 | | | |
| Threshold 3 ≥ | 4 | 4 | 7 |
| RSRP | | | |

In some examples, the configuration may be broadcast or indicated via a SIB (e.g., SIB2, SIB4), or may be provided via dedicated signaling (e.g., RRC release message) transmitted by the network entity 105-B. The one or more thresholds (e.g., Thresholds 1, 2, 3), along with the associated priorities for the serving cell (e.g., frequency layer 305-C) and the other frequency layers 305 (e.g., 305-A, 305-B), may be indicated or configured via the control signaling (e.g., SIB, RRC release message). In some examples, the network entity 105-B may set or define the thresholds based on the coverage area of the frequency layers 305. In some examples, the network entity 105-B may set or define the thresholds based on one or more other parameters.

In some cases, the control signaling may include multiple frequency layer measurement configurations. For example, the network entity 105-B may broadcast a SIB, which may not be a UE-specific message. The SIB may indicate multiple frequency layer measurement configurations that may correspond to different frequency layers. The UE 115-B may determine to use the frequency layer measurement configuration that may correspond to the frequency layer 305-C in which the UE 115-B may be camped.

In some implementations, the network entity 105-B may configure or indicate an upper boundary for cell coverage (e.g., an upper bound on RSRP, RSRQ, or both for a frequency layer 305). For example, each frequency layer 305 may be associated with one or more thresholds. The UE may perform inter-frequency measurements if the RSRP, RSRQ, or both of the serving cell (e.g., the frequency layer 305-C) are above the upper bound (e.g., the one or more configured thresholds). In some cases, the network entity 105-B may indicate a lower bound for cell coverage at a frequency layer 305 to the UEs 115 (e.g., Qᵣₓₗₑᵥₘᵢₙ, Q_{rxqualmin} (minimum RSRP value or RSRQ value)). The upper bounds, lower bounds, or both may be indicated to the UEs 115 via the control signaling (e.g., SIB (SIB2, SIB4), RRC release message).

In some cases, the indicated upper bound may be associated with the serving cell (e.g., frequency layer 305-C). For example, the UE 115-B may receive, via the frequency layer 305-C, a SIB indicating thresholds for the frequency layer 305-C. In other cases, the indicated upper bound may be associated with any frequency layer 305 that the UE 115 may have measured (e.g., non-serving cells). For example, the UE 115-B may be an idle or inactive UE (e.g., may not have a serving cell), and may receive an RRC release message indicating information for the frequency layer 305-C, which may be a frequency layer 305 that the UE 115-B may have used in the past.

In some cases, the indicated upper bound, or threshold, may be associated with a list of other frequency layers 305 to measure. For example, if the RSRP of the frequency layer 305-C, measured by the UE 115-C, exceeds a first threshold, the UE 115-C may perform inter-frequency measurements on the frequency layers 305-A and 305-B based on a list of frequency layers 305 associated with the first threshold. Table 2 provides an example of the association between thresholds and frequency layers for the UEs 115 to measure.

TABLE 2
Example of Association between RSRP of Frequency Layer
305-C and Other Frequency Layers 305 to Measure for
a UE 115 Camped in the Frequency Layer 305-C.

| RSRP of Frequency Layer | |
|---|---|
| 305-C | Frequency Layers to Measure |
| RSRP > Upper Bound 1 | Frequency Layer 305-A |
| RSRP > Upper Bound 2 | Frequency Layer 305-A, |
| (Upper Bound 2 < Upper Bound 1) | Frequency Layer 305-B |
| Otherwise | No Measurements |

In some examples, the configuration may be broadcast or indicated via a SIB, or may be provided via dedicated signaling (e.g., RRC release message). The one or more upper bounds (e.g., Upper Bounds 1, 2, 3), along with the list of frequency layers 305 to measure, may be indicated or configured via the control signaling (e.g., SIB, RRC release message). In some examples, the UE 115 may perform measurements on frequency layers 305, within the list of frequency layers 305, with higher priorities than the current frequency layer 305. In some cases, the one or more upper bounds may be indicated, and the UE 115 may perform measurements on any higher priority frequency layer, with respect to the current frequency layer. That is, the inter-frequency measurements may be limited to higher priority frequency layers 305.

In some cases, as described herein, the control signaling may include multiple frequency layer measurement configurations. For example, the SIB may indicate multiple frequency layer measurement configurations that may correspond to different frequency layers. A UE 115 may determine to use the frequency layer measurement configuration that may correspond to the frequency layer 305 in which the UE 115 may be camped. For example, the UE 115-C may determine to use the frequency layer measurement configuration that may correspond to the frequency layer 305-C.

After performing the inter-frequency measurements, if the RSRP, RSRQ, or both of the measured frequency layers 305 satisfy one or more thresholds, the UE 115 may reselect one of the measured frequency layers 305. For example, the UE 115-C may perform measurements on the frequency layer 305-A based on the RSRP of the frequency layer 305-C, as measured at the UE 115-C, exceeding Upper Bound 1. The UE 115-C may reselect the frequency layer 305-A, or may switch from the frequency layer 305-C to the frequency layer 305-A, based on the inter-frequency measurements of the frequency layer 305-A satisfying one or more configured thresholds (e.g., Srxlev and Squal satisfying S_{nonIntraSearchP} and S_{nonIntraSearchQ}).

In some cases, the network entity 105-B may indicate the one or more lower bounds for cell coverage at a frequency layer 305 to the UEs 115 (e.g., Qᵣₓₗₑᵥₘᵢₙ, Q_{rxqualmin}). If the RSRP, RSRQ, or both of the serving cell (e.g., frequency layer 305-C for UEs 115-B and 115-C) are below the configured lower bounds (e.g., Srxlev and Squal below Qᵣₓₗₑᵥₘᵢₙ and Q_{rxqualmin}, respectively), the UE 115 may perform measurements on all available frequency layers 305, or all frequency layers with a higher priority. For example, the UE 115-B may measure an RSRP, RSRQ, or both for the frequency layer 305-C below the lower bound(s). The UE 115-B may then measure the frequency layers 305-A and 305-B, based on the frequency layer 305-C being of poor quality or power. In some examples, the UE 115-B may measure all of the frequency layers 305 indicated in the configuration, such as the lists of frequency layers 305 associated with the upper bounds.

In some cases, the network entity 105-B may define multiple ranges of cell coverage, determined by multiple upper bounds, and each range may be associated with a list of frequency layers to measure, as in Table 3. This may be provided to the UE 115 via the control signaling.

TABLE 3
Example of Association between RSRP Ranges of Frequency
Layer 305-C and Other Frequency Layers 305 to Measure
for a UE 115 Camped in the Frequency Layer 305-C.

| Range of Coverage Based on | |
|---|---|
| RSRP of Frequency Layer | |
| 305-C | Frequency Layers 305 to Measure |
| RSRP > Upper Bound 1 | Frequency Layer 305-A |
| Upper Bound 1 ≥ RSRP > Upper | Frequency Layer 305-A, |
| Bound 2 | Frequency Layer 305-B |
| Upper Bound 2 ≥ RSRP > Upper | Frequency Layer 305-B |
| Bound 3 | |
| Upper Bound 3 ≥ RSRP | No Measurements |

With respect to coverage diagram 301, in some implementations, frequency layers 305 may be provided by multiple network entities 105 (e.g., co-site multi-frequency layer deployment). In some cases, co-located network entities 105-C and 105-D may provide frequency layers 305. For example, network entity 105-C may provide frequency layer 305-D and 305-E, while network entity 105-D may provide frequency layer 305-F. In some cases, non-co-located network entities may also provide frequency layers. For example, network entity 105-E may provide frequency layer 305-G. The UE 115-D may operate according to frequency layer 305-F, and may perform measurements of the RSRP, RSRQ, or both of frequency layer 305-F. The RSRP may be relatively low, or below a threshold or upper bound, so the UE 115-D may determine not to perform inter-frequency measurements. However, the frequency layer 305-G may be of high priority, and the UE 115-D may be within the coverage area of the frequency layer 305-G because the network entity 105-E may not be co-located with the network entities 105-C and 105-D. The UE 115-D may use some co-location information to determine whether to perform inter-frequency measurements on the frequency layer 305-G.

In some cases, devices may be considered co-located, or co-site, if the distance between the two devices is less than some threshold distance (e.g., 5m, 10m). In some examples, the location of the network entities 105 may be known by a network based on geo-positioning system (e.g., outdoor deployment). If a network includes two or more frequency layers 305, a reference frequency layer 305 (e.g., a frequency layer 305 with a lowest frequency) may be used to determine distances between network entities that provide frequency layers 305.

In some implementations, a network, such as via network entity 105-D, may provide an indication of co-location information for the frequency layers 305. The information may be a binary indication (e.g., co-located, not co-located), may indicate a distance between network entities 105 or cells associated with the network entities, or may be a threshold distance between two or more inter-frequency cells in a geographical area. In some examples, there may be multiple cells for a frequency layer within a geographical area. The information may be a non-binary indication. For example, the non-binary indication may be that two cells are co-located, loosely co-located, or non-collocated, where the cells may be distinguished based on distance as discussed herein. In another example, the non-binary indication may be a defined distance (e.g., maximum distance) between two or multiple inter-frequency cells in a geographical area. In some cases, there may be multiple cells for each frequency layer depending on how large a geographical area is defined. In some cases, the co-location information may be indicated via control signaling, which may be broadcast (e.g., SIB (SIB2, SIB4)) or may be dedicated signaling (e.g., RRC release messages). For broadcasted information, which may be broadcast via a frequency layer 305, the network entity 105 may indicate co-location information for the other frequency layers (e.g., which frequency layers 305 it is co-located with). For example, the network entity 105-D may broadcast, via the frequency layer 305-F, co-location information indicating that the network entity 105-D is co-located with the network entity 105-C. The UE 115-D may use such co-location information, along with system synchronization block (SSB) strength (RSRP, RSRQ, or both) across different frequency layers to determine coverage boundaries for the frequency layers 305. Thus, the UE 115-D may avoid performing unnecessary measurements of frequency layers 305, such as frequency layers 305-D and 305-E, when the coverage of frequency layers 305 may not reach the location of the UE 115-D. However, the UE 115-D may perform inter-frequency measurements on the frequency layer 305-G, if the frequency layer 305-G is of higher priority than the UE 115-D.

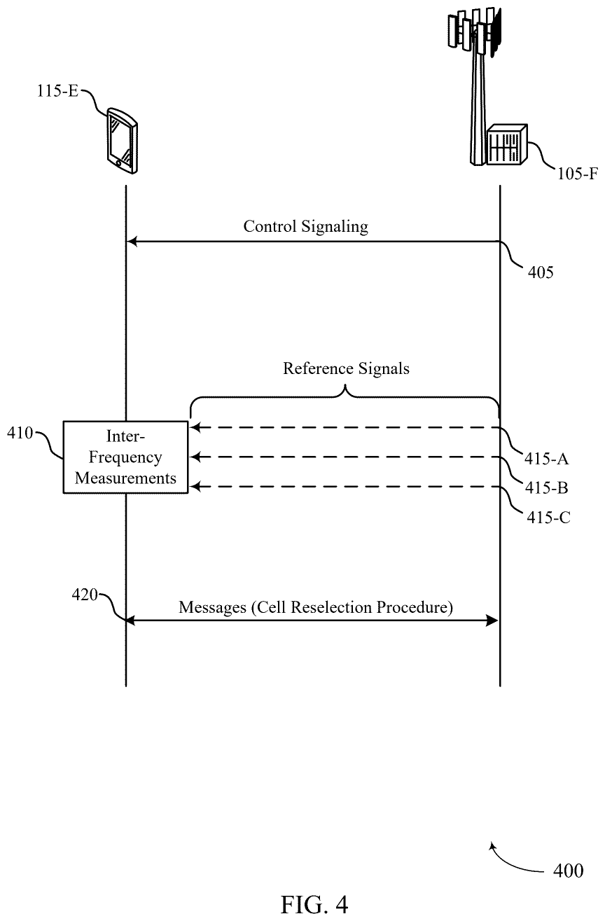

FIG. 4 shows an example of a process flow 400 that supports enhanced frequency layer measurements in accordance with one or more aspects of the present disclosure. The process flow 400 may implement, or be implemented by, aspects of the wireless communications systems 100 and 200, and the coverage diagrams 300 and 301. For example, the process flow 400 may include one or more network entities 105 and UEs 115, including at least the network entity 105-F and the UE 115-E, which may be examples of corresponding devices as described herein, including with reference to FIGS. 1, 2, 3A, and 3B. The techniques described herein in the context of the process flow 400 may support the network entity 105-F to configure the UE 115-E with thresholds for performing inter-frequency measurements on higher priority cells as part of a cell reselection procedure.

At 405, the UE 115-E may receive, and the network entity 105-F may output, control signaling that may indicate a frequency layer measurement configuration of the network entity 105-F. The frequency layer measurement configuration may indicate at least one threshold associated with a first frequency layer (e.g., current frequency layer, camped cell, serving cell, given frequency layer) for triggering measurement of a second frequency layer that is of higher priority than the first frequency layer. In some cases, receiving the control signaling may include receiving a SIB or an RRC message indicating the frequency layer measurement configuration. In some cases, the first frequency layer may be associated with a serving cell for the UE 115-E or a non-serving cell for the UE 115-E. In some examples, the control signaling may indicate multiple frequency layer measurement configurations associated with multiple frequency layers, where the frequency layer measurement configuration may be associated with the first frequency layer.

In some cases, the second frequency layer may be of higher priority than the first frequency layer based on a measurement of the first frequency layer (e.g., by the UE 115-E) satisfying the at least one threshold. That is, the RSRP, RSRQ, or both of the first frequency layer may satisfy the at least one threshold, which may indicate the priority of the second frequency layer as higher than that of the first frequency layer (e.g., an adaptive frequency layer prioritization scheme, as in Table 1). In some cases, the frequency layer measurement configuration may identify multiple thresholds associated with multiple priorities for multiple frequency layers, where a priority of the multiple priorities for the second frequency layer of the multiple frequency layers may be based on the measurement of the first frequency layer of the multiple frequency layers being within a range of values defined by a first threshold and a second threshold of the multiple thresholds (e.g., as in Table 1).

In some cases, the frequency layer measurement configuration may indicate that the at least one threshold may correspond to a bound value (e.g., an upper bound) for a signal metric (e.g., RSRP, RSRQ), and the frequency layer measurement configuration may indicate to measure one or more frequency layers different than the first frequency layer (e.g., inter-frequency measurements, as at 410) based on the measurement of the first frequency layer satisfying the bound value (e.g., as in Tables 2 and 3). In some examples, the one or more frequency layers may be of higher priority than the first frequency layer. In some cases, the at least one threshold may include a first threshold and a second threshold that define a range of values, and one or more inter-frequency measurements of the second frequency layer, as described at 410, may be performed based on the measurement of the first frequency layer being within the range of values. In some cases, the frequency layer measurement configuration may indicate to measure one or more second frequency layers different than the first frequency layer based on the measurement of the first frequency layer failing to satisfy a second bound value (e.g., a lower bound value, minimum bound value).

In some cases, the frequency layer measurement configuration may indicate location information (e.g., co-location information) associated with a coverage area of the second frequency layer, and the UE 115-E may perform the one or more inter-frequency measurements of the second frequency layer at 410 on the UE being located within the coverage area. In some examples, the location information may indicate that the coverage area of the second frequency layer is co-located with a coverage area of the first frequency layer. In some examples, the location information may indicate a threshold distance between the coverage area of the second frequency layer and a coverage area of the first frequency layer.

At 410, the UE 115-A may perform, based on a measurement of the first frequency layer satisfying the at least one threshold, one or more inter-frequency measurements of the second frequency layer. In some cases, the measurement of the first frequency layer may include an RSRP, an RSRQ, or both. In some cases, the one or more inter-frequency measurements may include an RSRP, an RSRQ, or both.

In some implementations, at 415, the network entity 105-F may output reference signals. The UE 115-A may perform the inter-frequency measurements at 410 based on the network entity 105-F outputting reference signals at 415. For example, the UE 115-A may measure the reference signals, which may be associated with one or more frequency layers different from the first frequency layer. That is, one or more reference signal at 415-A may be associated with the second frequency layer, while one or more reference signals at 415-B may be associated with a third frequency layer. In some cases, the network entity 105-F may also output one or more reference signals for the first frequency layer, which the UE 115-A may measure to determine if the measurement of the first frequency layer satisfies the at least one threshold. In some cases, the reference signals at 415 may not all be output by the same network entity 105. That is, the network entity 105-F may include multiple network entities. For example, the network entity 105-F may include a first network entity and a second network entity, where the control signaling may be output via the first network entity and one or more messages (e.g., as part of a cell reselection procedure) may be communicated via the second network entity.

At 420, the UE 115-E and the network entity 105-F may communicate one or more messages as part of a cell reselection procedure associated with the second frequency layer based on the one or more inter-frequency measurements. In some cases, the one or more messages are communicated as part of the cell reselection procedure based on at least one of the one or more inter-frequency measurements of the second frequency layer satisfying a cell reselection procedure threshold (e.g., Srxlev, Squal for the second frequency layer satisfying configured thresholds). The one or more messages of the cell reselection procedure (e.g., cell switch request, cell switch command, random access procedure message, etc.) may involve the UE 115-E communicating with the network entity 105-F to switch to a different cell, where the different cell may be operated by the network entity 105-F or a different network entity 105.

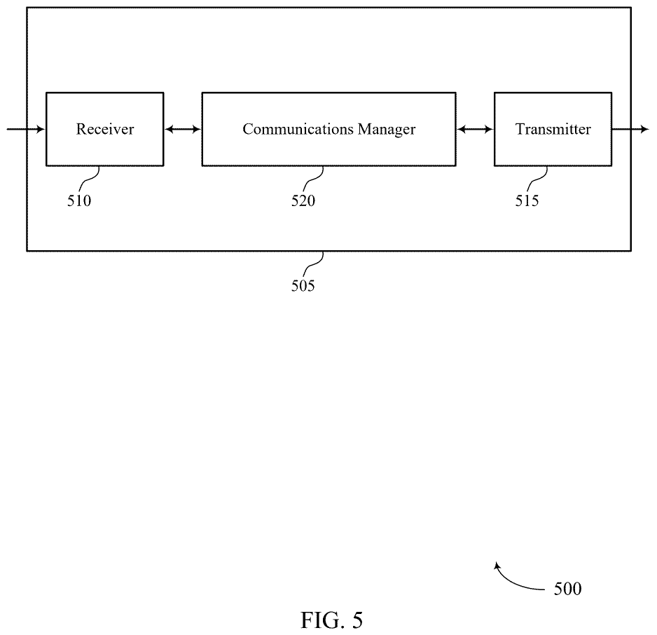

FIG. 5 shows a block diagram 500 of a device 505 that supports enhanced frequency layer measurements in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhanced frequency layer measurements). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhanced frequency layer measurements). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of enhanced frequency layer measurements as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer. The communications manager 520 is capable of, configured to, or operable to support a means for performing, based on a measurement of the first frequency layer satisfying the at least one threshold, one or more inter-frequency measurements of the second frequency layer. The communications manager 520 is capable of, configured to, or operable to support a means for communicating one or more messages as part of a cell reselection procedure associated with the second frequency layer based on the one or more inter-frequency measurements.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

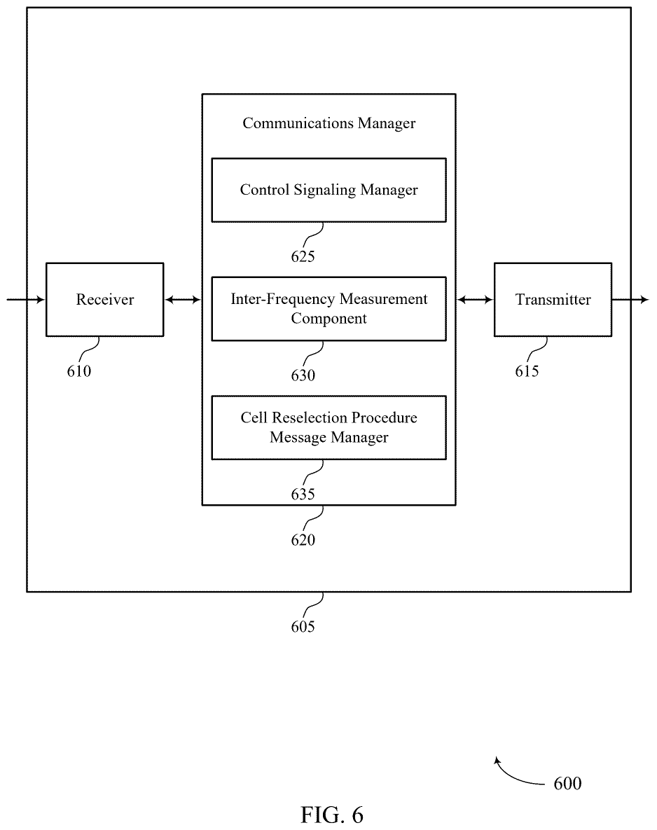

FIG. 6 shows a block diagram 600 of a device 605 that supports enhanced frequency layer measurements in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhanced frequency layer measurements). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhanced frequency layer measurements). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhanced frequency layer measurements as described herein. For example, the communications manager 620 may include a control signaling manager 625, an inter-frequency measurement component 630, a cell reselection procedure message manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control signaling manager 625 is capable of, configured to, or operable to support a means for receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer. The inter-frequency measurement component 630 is capable of, configured to, or operable to support a means for performing, based on a measurement of the first frequency layer satisfying the at least one threshold, one or more inter-frequency measurements of the second frequency layer. The cell reselection procedure message manager 635 is capable of, configured to, or operable to support a means for communicating one or more messages as part of a cell reselection procedure associated with the second frequency layer based on the one or more inter-frequency measurements.

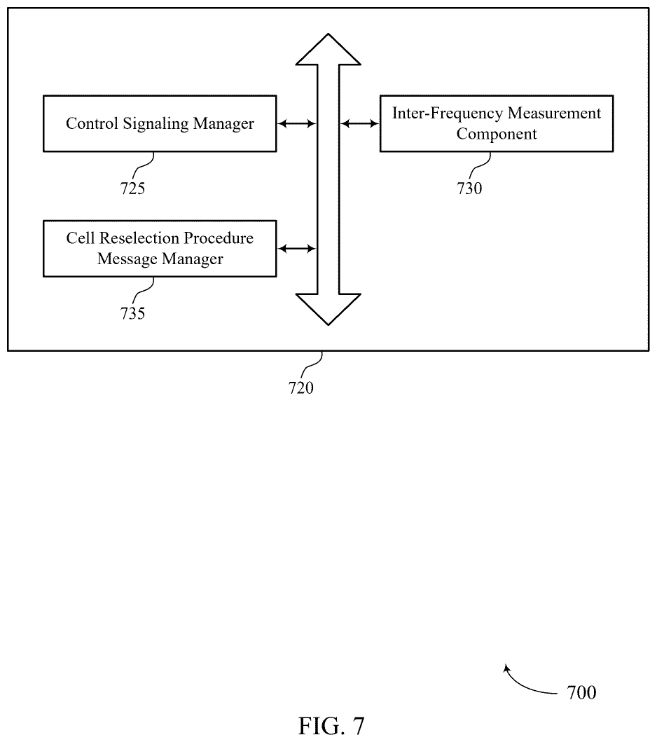

FIG. 7 shows a block diagram 700 of a communications manager 720 that supports enhanced frequency layer measurements in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enhanced frequency layer measurements as described herein. For example, the communications manager 720 may include a control signaling manager 725, an inter-frequency measurement component 730, a cell reselection procedure message manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control signaling manager 725 is capable of, configured to, or operable to support a means for receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer. The inter-frequency measurement component 730 is capable of, configured to, or operable to support a means for performing, based on a measurement of the first frequency layer satisfying the at least one threshold, one or more inter-frequency measurements of the second frequency layer. The cell reselection procedure message manager 735 is capable of, configured to, or operable to support a means for communicating one or more messages as part of a cell reselection procedure associated with the second frequency layer based on the one or more inter-frequency measurements.

In some examples, the second frequency layer is of higher priority than the first frequency layer based on the measurement of the first frequency layer satisfying the at least one threshold.

In some examples, to support receiving the control signaling, the control signaling manager 725 is capable of, configured to, or operable to support a means for receiving the control signaling indicating the frequency layer measurement configuration that identifies a set of multiple thresholds associated with a set of multiple priorities for a set of multiple frequency layers, where a priority of the set of multiple priorities for the second frequency layer of the set of multiple frequency layers is based on the measurement of the first frequency layer of the set of multiple frequency layers being within a range of values defined by a first threshold and a second threshold of the set of multiple thresholds.

In some examples, the control signaling indicates a plurality of frequency layer measurement configurations associated with a plurality of frequency layers, wherein the frequency layer measurement configuration is associated with the first frequency layer.

In some examples, the frequency layer measurement configuration indicates that the at least one threshold corresponds to a bound value for a signal metric. In some examples, the frequency layer measurement configuration indicates to measure one or more frequency layers different than the first frequency layer based on the measurement of the first frequency layer satisfying the bound value.

In some examples, the one or more frequency layers are of higher priority than the first frequency layer.

In some examples, the frequency layer measurement configuration indicates to measure one or more second frequency layers different than the first frequency layer based on the measurement of the first frequency layer failing to satisfy a second bound value.

In some examples, the at least one threshold includes a first threshold and a second threshold that define a range of values. In some examples, the one or more inter-frequency measurements of the second frequency layer are performed based on the measurement of the first frequency layer being within the range of values.

In some examples, the one or more messages are communicated as part of the cell reselection procedure based on at least one of the one or more inter-frequency measurements of the second frequency layer satisfying a cell reselection procedure threshold.

In some examples, the frequency layer measurement configuration indicates location information associated with a coverage area of the second frequency layer. In some examples, the one or more inter-frequency measurements of the second frequency layer are performed based on the UE being located within the coverage area.

In some examples, the location information indicates that the coverage area of the second frequency layer is co-located with a coverage area of the first frequency layer.

In some examples, the location information indicates a threshold distance between the coverage area of the second frequency layer and a coverage area of the first frequency layer.

In some examples, the one or more inter-frequency measurements include a reference signal received power, a reference signal received quality, or both.

In some examples, the measurement of the first frequency layer includes a reference signal received power, a reference signal received quality, or both.

In some examples, to support receiving the control signaling, the control signaling manager 725 is capable of, configured to, or operable to support a means for receiving a system information block or an RRC message indicating the frequency layer measurement configuration.

In some examples, the first frequency layer is associated with a serving cell for the UE or a non-serving cell for the UE.

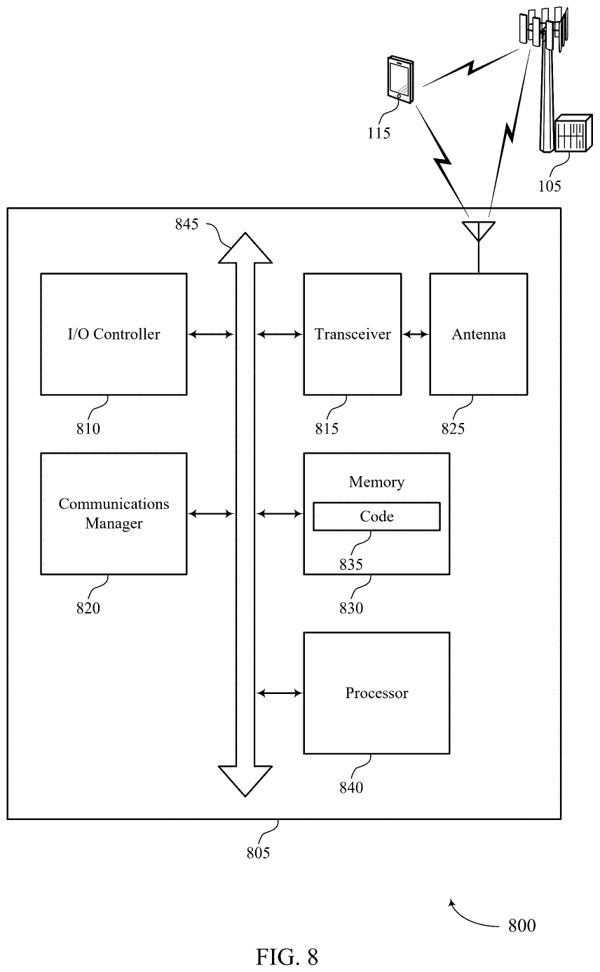

FIG. 8 shows a diagram of a system 800 including a device 805 that supports enhanced frequency layer measurements in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting enhanced frequency layer measurements). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling that indicates a frequency layer measurement configuration of a network entity, where the frequency layer measurement configuration indicates at least one threshold associated with a first frequency layer for triggering measurement of a second frequency layer that is of higher priority than the first frequency layer. The communications manager 820 is capable of, configured to, or operable to support a means for performing, based on a measurement of the first frequency layer satisfying the at least one threshold, one or more inter-frequency measurements of the second frequency layer. The communications manager 820 is capable of, configured to, or operable to support a means for communicating one or more messages as part of a cell reselection procedure associated with the second frequency layer based on the one or more inter-frequency measurements.

By including or configuring the communications manager 820 in accordance with examples as described herein, the device 805 may support techniques for reduced latency, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described herein with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of enhanced frequency layer measurements as described herein, or the at least one processor 840 and the at least one memory 830 may be otherwise configured to, individually or collectively, perform or support such operations.

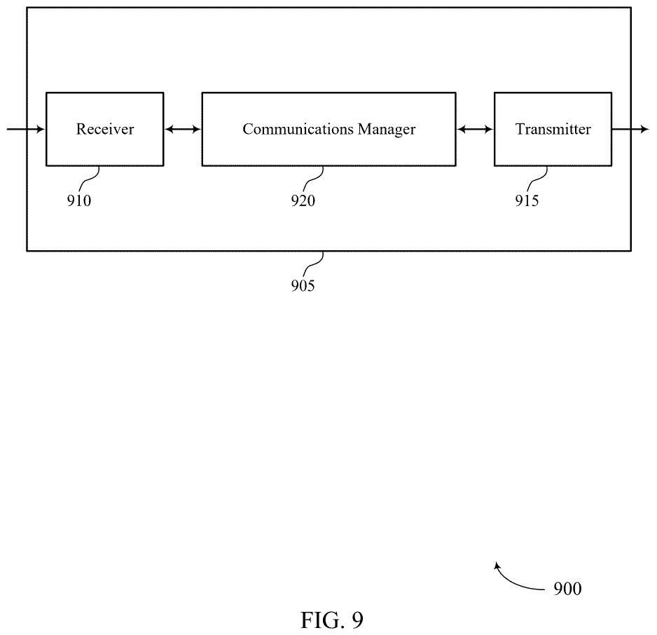

FIG. 9 shows a block diagram 900 of a device 905 that supports enhanced frequency layer measurements in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor (not shown), which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of enhanced frequency layer measurements as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer. The communications manager 920 is capable of, configured to, or operable to support a means for communicating one or more messages as part of a cell reselection procedure associated with the second frequency layer based on the control signaling.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

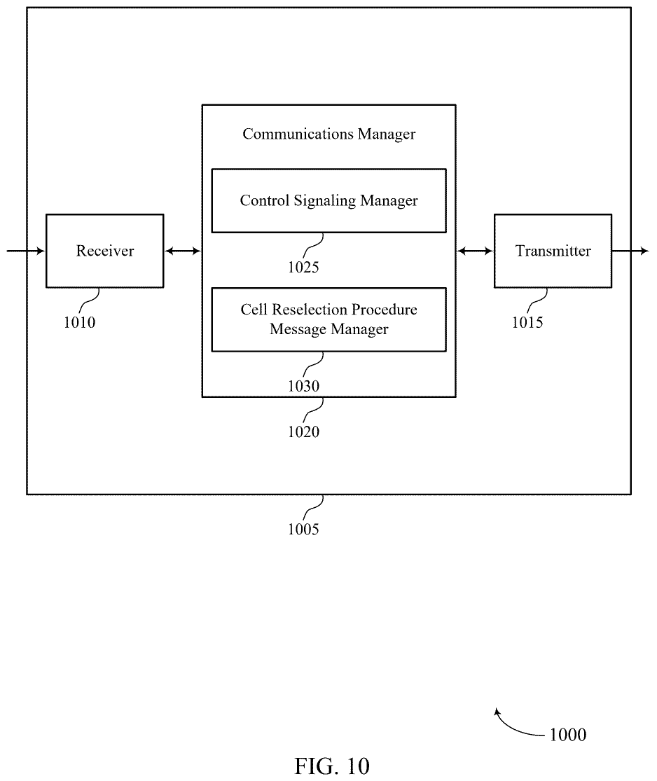

FIG. 10 shows a block diagram 1000 of a device 1005 that supports enhanced frequency layer measurements in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor (not shown), which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of enhanced frequency layer measurements as described herein. For example, the communications manager 1020 may include a control signaling manager 1025 a cell reselection procedure message manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control signaling manager 1025 is capable of, configured to, or operable to support a means for outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer. The cell reselection procedure message manager 1030 is capable of, configured to, or operable to support a means for communicating one or more messages as part of a cell reselection procedure associated with the second frequency layer based on the control signaling.

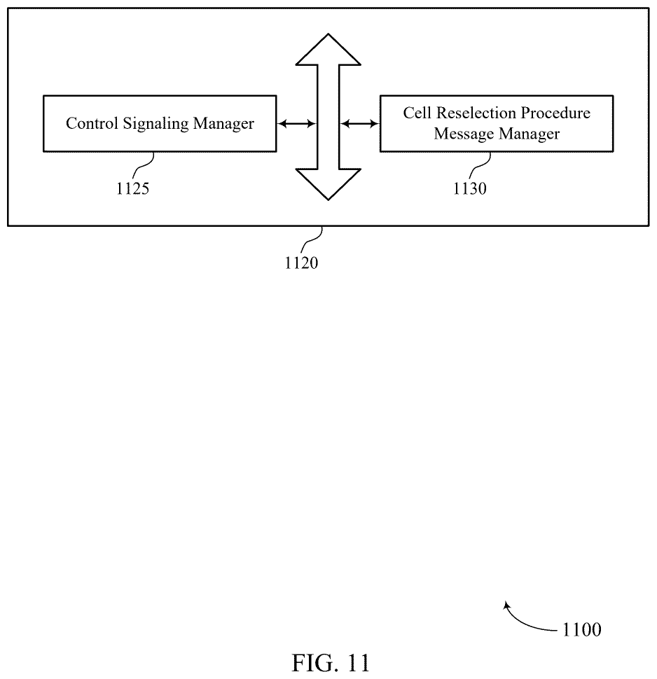

FIG. 11 shows a block diagram 1100 of a communications manager 1120 that supports enhanced frequency layer measurements in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of enhanced frequency layer measurements as described herein. For example, the communications manager 1120 may include a control signaling manager 1125 a cell reselection procedure message manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control signaling manager 1125 is capable of, configured to, or operable to support a means for outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer. The cell reselection procedure message manager 1130 is capable of, configured to, or operable to support a means for communicating one or more messages as part of a cell reselection procedure associated with the second frequency layer based on the control signaling.

In some examples, to support outputting the control signaling, the control signaling manager 1125 is capable of, configured to, or operable to support a means for outputting the control signaling indicating the frequency layer measurement configuration that identifies a set of multiple thresholds associated with a set of multiple priorities for a set of multiple frequency layers.

In some examples, the control signaling indicates a plurality of frequency layer measurement configurations associated with a plurality of frequency layers, wherein the frequency layer measurement configuration is associated with the first frequency layer.

In some examples, the frequency layer measurement configuration indicates that the at least one threshold corresponds to a bound value for a signal metric. In some examples, the frequency layer measurement configuration indicates to measure one or more frequency layers different than the first frequency layer based on a measurement of the first frequency layer satisfying the bound value.

In some examples, the one or more frequency layers are of higher priority than the first frequency layer.

In some examples, the frequency layer measurement configuration indicates to measure one or more second frequency layers different than the first frequency layer based on the measurement of the first frequency layer failing to satisfy a second bound value.

In some examples, the at least one threshold includes a first threshold and a second threshold that define a range of values.

In some examples, the frequency layer measurement configuration indicates location information associated with a coverage area of the second frequency layer.

In some examples, the location information indicates that the coverage area of the second frequency layer is co-located with a coverage area of the first frequency layer.

In some examples, the location information indicates a threshold distance between the coverage area of the second frequency layer and a coverage area of the first frequency layer.

In some examples, the network entity includes a first network entity and a second network entity. In some examples, the control signaling is output via the first network entity and the one or more messages are communicated via the second network entity.

In some examples, to support outputting the control signaling, the control signaling manager 1125 is capable of, configured to, or operable to support a means for outputting a system information block or an RRC message indicating the frequency layer measurement configuration.

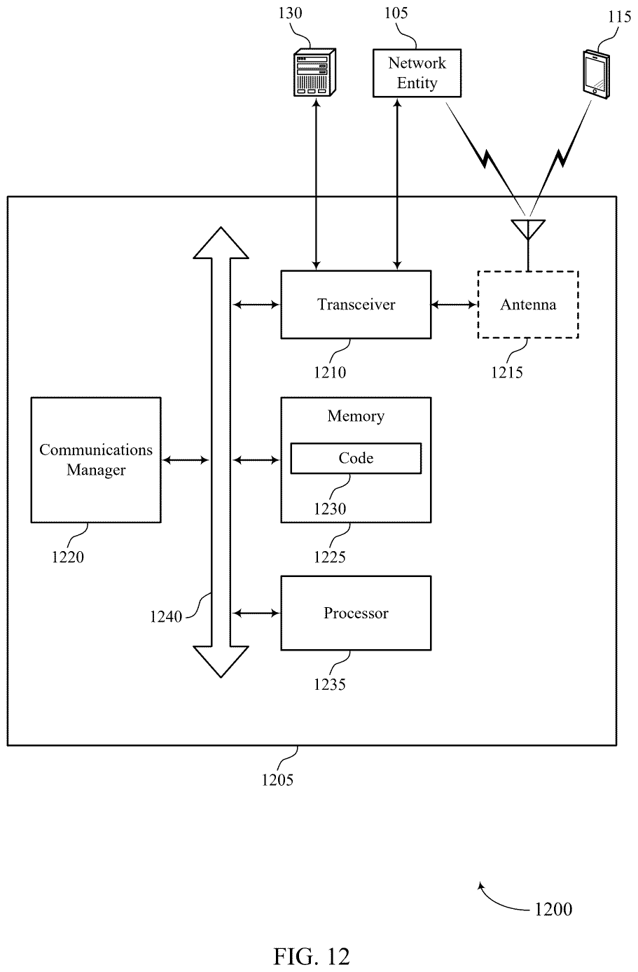

FIG. 12 shows a diagram of a system 1200 including a device 1205 that supports enhanced frequency layer measurements in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting enhanced frequency layer measurements). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting control signaling that indicates a frequency layer measurement configuration of the network entity, where the frequency layer measurement configuration indicates at least one threshold associated with a first frequency layer for triggering measurement of a second frequency layer that is of higher priority than the first frequency layer. The communications manager 1220 is capable of, configured to, or operable to support a means for communicating one or more messages as part of a cell reselection procedure associated with the second frequency layer based on the control signaling.

By including or configuring the communications manager 1220 in accordance with examples as described herein, the device 1205 may support techniques for reduced latency, reduced power consumption, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described herein with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of enhanced frequency layer measurements as described herein, or the at least one processor 1235 and the at least one memory 1225 may be otherwise configured to, individually or collectively, perform or support such operations.

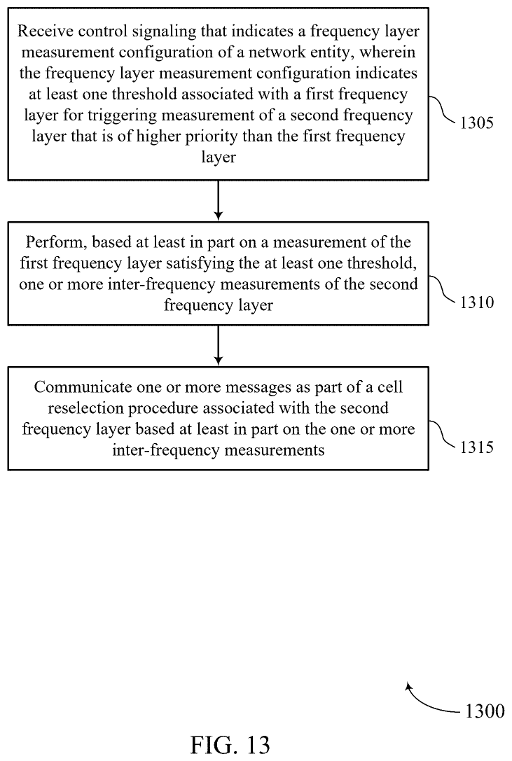

FIG. 13 shows a flowchart illustrating a method 1300 that supports enhanced frequency layer measurements in accordance with one or more aspects of the present disclosure. The operations of the method 1300 may be implemented by a UE or its components as described herein. For example, the operations of the method 1300 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates a frequency layer measurement configuration of a network entity, wherein the frequency layer measurement configuration indicates at least one threshold associated with a first frequency layer for triggering measurement of a second frequency layer that is of higher priority than the first frequency layer. The operations of 1305 may be performed in accordance with examples as disclosed herein. In some examples, aspects of the operations of 1305 may be performed by a control signaling manager 725 as described herein with reference to FIG. 7.

At 1310, the method may include performing, based at least in part on a measurement of the first frequency layer satisfying the at least one threshold, one or more inter-frequency measurements of the second frequency layer. The operations of 1310 may be performed in accordance with examples as disclosed herein. In some examples, aspects of the operations of 1310 may be performed by an inter-frequency measurement component 730 as described herein with reference to FIG. 7.

At 1315, the method may include communicating one or more messages as part of a cell reselection procedure associated with the second frequency layer based at least in part on the one or more inter-frequency measurements. The operations of 1315 may be performed in accordance with examples as disclosed herein. In some examples, aspects of the operations of 1315 may be performed by a cell reselection procedure message manager 735 as described herein with reference to FIG. 7.

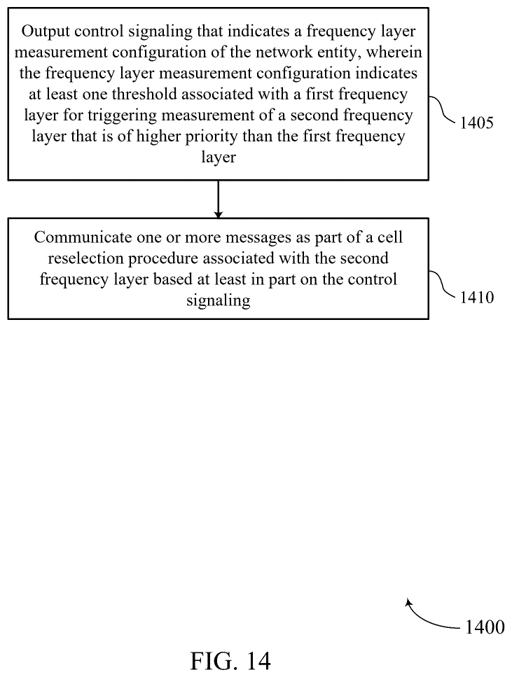

FIG. 14 shows a flowchart illustrating a method 1400 that supports enhanced frequency layer measurements in accordance with one or more aspects of the present disclosure. The operations of the method 1400 may be implemented by a network entity or its components as described herein. For example, the operations of the method 1400 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting control signaling that indicates a frequency layer measurement configuration of the network entity, wherein the frequency layer measurement configuration indicates at least one threshold associated with a first frequency layer for triggering measurement of a second frequency layer that is of higher priority than the first frequency layer. The operations of 1405 may be performed in accordance with examples as disclosed herein. In some examples, aspects of the operations of 1405 may be performed by a control signaling manager 1125 as described herein with reference to FIG. 11.

At 1410, the method may include communicating one or more messages as part of a cell reselection procedure associated with the second frequency layer based at least in part on the control signaling. The operations of 1410 may be performed in accordance with examples as disclosed herein. In some examples, aspects of the operations of 1410 may be performed by a cell reselection procedure message manager 1130 as described herein with reference to FIG. 11.

The following provides an overview of aspects of the present disclosure:

Aspect 1: A method for wireless communications at a UE, comprising: receiving control signaling that indicates a frequency layer measurement configuration of a network entity, wherein the frequency layer measurement configuration indicates at least one threshold associated with a first frequency layer for triggering measurement of a second frequency layer that is of higher priority than the first frequency layer; performing, based at least in part on a measurement of the first frequency layer satisfying the at least one threshold, one or more inter-frequency measurements of the second frequency layer; and communicating one or more messages as part of a cell reselection procedure associated with the second frequency layer based at least in part on the one or more inter-frequency measurements.

Aspect 2: The method of aspect 1, wherein the second frequency layer is of higher priority than the first frequency layer based at least in part on the measurement of the first frequency layer satisfying the at least one threshold.

Aspect 3: The method of any of aspects 1 through 2, wherein receiving the control signaling further comprises: receiving the control signaling indicating the frequency layer measurement configuration that identifies a plurality of thresholds associated with a plurality of priorities for a plurality of frequency layers, wherein a priority of the plurality of priorities for the second frequency layer of the plurality of frequency layers is based at least in part on the measurement of the first frequency layer of the plurality of frequency layers being within a range of values defined by a first threshold and a second threshold of the plurality of thresholds.

Aspect 4: The method of any of aspects 1 through 3, wherein the control signaling indicates a plurality of frequency layer measurement configurations associated with a plurality of frequency layers, wherein the frequency layer measurement configuration is associated with the first frequency layer.

Aspect 5: The method of any of aspects 1, 2, or 4, wherein the frequency layer measurement configuration indicates that the at least one threshold corresponds to a bound value for a signal metric, and the frequency layer measurement configuration indicates to measure one or more frequency layers different than the first frequency layer based at least in part on the measurement of the first frequency layer satisfying the bound value.

Aspect 6: The method of aspect 5, wherein the one or more frequency layers are of higher priority than the first frequency layer.

Aspect 7: The method of any of aspects 5 through 6, wherein the frequency layer measurement configuration indicates to measure one or more second frequency layers different than the first frequency layer based at least in part on the measurement of the first frequency layer failing to satisfy a second bound value.

Aspect 8: The method of any of aspects 1 through 7, wherein the at least one threshold comprises a first threshold and a second threshold that define a range of values, and the one or more inter-frequency measurements of the second frequency layer are performed based at least in part on the measurement of the first frequency layer being within the range of values.

Aspect 9: The method of any of aspects 1 through 8, wherein the one or more messages are communicated as part of the cell reselection procedure based at least in part on at least one of the one or more inter-frequency measurements of the second frequency layer satisfying a cell reselection procedure threshold.

Aspect 10: The method of any of aspects 1 through 9, wherein the frequency layer measurement configuration indicates location information associated with a coverage area of the second frequency layer, and the one or more inter-frequency measurements of the second frequency layer are performed based at least in part on the UE being located within the coverage area.

Aspect 11: The method of aspect 10, wherein the location information indicates that the coverage area of the second frequency layer is co-located with a coverage area of the first frequency layer.

Aspect 12: The method of any of aspects 10 through 11, wherein the location information indicates a threshold distance between the coverage area of the second frequency layer and a coverage area of the first frequency layer.

Aspect 13: The method of any of aspects 1 through 12, wherein the one or more inter-frequency measurements comprise a RSRP, a RSRQ, or both.

Aspect 14: The method of any of aspects 1 through 13, wherein the measurement of the first frequency layer comprises a RSRP, a RSRQ, or both.

Aspect 15: The method of any of aspects 1 through 14, wherein receiving the control signaling further comprises: receiving a SIB or an RRC message indicating the frequency layer measurement configuration.

Aspect 16: The method of any of aspects 1 through 15, wherein the first frequency layer is associated with a serving cell for the UE or a non-serving cell for the UE.

Aspect 17: A method for wireless communications at a network entity, comprising: outputting control signaling that indicates a frequency layer measurement configuration of the network entity, wherein the frequency layer measurement configuration indicates at least one threshold associated with a first frequency layer for triggering measurement of a second frequency layer that is of higher priority than the first frequency layer; and communicating one or more messages as part of a cell reselection procedure associated with the second frequency layer based at least in part on the control signaling.

Aspect 18: The method of aspect 17, wherein outputting the control signaling further comprises: outputting the control signaling indicating the frequency layer measurement configuration that identifies a plurality of thresholds associated with a plurality of priorities for a plurality of frequency layers.

Aspect 19: The method of any of aspects 17 through 18, wherein the control signaling indicates a plurality of frequency layer measurement configurations associated with a plurality of frequency layers, the frequency layer measurement configuration is associated with the first frequency layer.

Aspect 20: The method of any of aspects 17 or 19, wherein the frequency layer measurement configuration indicates that the at least one threshold corresponds to a bound value for a signal metric, and the frequency layer measurement configuration indicates to measure one or more frequency layers different than the first frequency layer based at least in part on a measurement of the first frequency layer satisfying the bound value.

Aspect 21: The method of aspect 20, wherein the one or more frequency layers are of higher priority than the first frequency layer.

Aspect 22: The method of any of aspects 20 through 21, wherein the frequency layer measurement configuration indicates to measure one or more second frequency layers different than the first frequency layer based at least in part on the measurement of the first frequency layer failing to satisfy a second bound value.

Aspect 23: The method of any of aspects 17 through 22, wherein the at least one threshold comprises a first threshold and a second threshold that define a range of values.

Aspect 24: The method of any of aspects 17 through 23, wherein the frequency layer measurement configuration indicates location information associated with a coverage area of the second frequency layer.

Aspect 25: The method of aspect 24, wherein the location information indicates that the coverage area of the second frequency layer is co-located with a coverage area of the first frequency layer.

Aspect 26: The method of any of aspects 24 through 25, wherein the location information indicates a threshold distance between the coverage area of the second frequency layer and a coverage area of the first frequency layer.

Aspect 27: The method of any of aspects 17 through 26, wherein the network entity comprises a first network entity and a second network entity, and the control signaling is output via the first network entity and the one or more messages are communicated via the second network entity.

Aspect 28: The method of any of aspects 17 through 27, wherein outputting the control signaling further comprises: outputting a SIB or an RRC message indicating the frequency layer measurement configuration.

Aspect 29: A UE for wireless communications, comprising one or more memories storing processor-executable code, and one or more processors coupled with the one or more memories and individually or collectively operable to execute the code to cause the UE to perform a method of any of aspects 1 through 16.

Aspect 30: A UE for wireless communications, comprising at least one means for performing a method of any of aspects 1 through 16.

Aspect 31: A non-transitory computer-readable medium storing code for wireless communications, the code comprising instructions executable by one or more processors to perform a method of any of aspects 1 through 16.

Aspect 32: A network entity for wireless communications, comprising one or more memories storing processor-executable code, and one or more processors coupled with the one or more memories and individually or collectively operable to execute the code to cause the network entity to perform a method of any of aspects 17 through 28.

Aspect 33: A network entity for wireless communications, comprising at least one means for performing a method of any of aspects 17 through 28.

Aspect 34: A non-transitory computer-readable medium storing code for wireless communications, the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a frequency layer measurement configuration of a network entity, wherein the frequency layer measurement configuration indicates at least one threshold associated with a first frequency layer for triggering measurement of a second frequency layer that is of higher priority than the first frequency layer;
perform, based at least in part on a measurement of the first frequency layer satisfying the at least one threshold, one or more inter-frequency measurements of the second frequency layer; and
communicate one or more messages as part of a cell reselection procedure associated with the second frequency layer based at least in part on the one or more inter-frequency measurements.

2. The UE of claim 1, wherein the second frequency layer is of higher priority than the first frequency layer based at least in part on the measurement of the first frequency layer satisfying the at least one threshold.

3. The UE of claim 1, wherein, to receive the control signaling, the one or more processors are individually or collectively further operable to execute the code to cause the UE to:
receive the control signaling indicating the frequency layer measurement configuration that identifies a plurality of thresholds associated with a plurality of priorities for a plurality of frequency layers, wherein a priority of the plurality of priorities for the second frequency layer of the plurality of frequency layers is based at least in part on the measurement of the first frequency layer of the plurality of frequency layers being within a range of values defined by a first threshold and a second threshold of the plurality of thresholds.

4. The UE of claim 1, wherein the control signaling indicates a plurality of frequency layer measurement configurations associated with a plurality of frequency layers, wherein the frequency layer measurement configuration is associated with the first frequency layer.

5. The UE of claim 1, wherein:
the frequency layer measurement configuration indicates that the at least one threshold corresponds to a bound value for a signal metric, and
the frequency layer measurement configuration indicates to measure one or more frequency layers different than the first frequency layer based at least in part on the measurement of the first frequency layer satisfying the bound value.

6. The UE of claim 5, wherein the one or more frequency layers are of higher priority than the first frequency layer.

7. The UE of claim 5, wherein the frequency layer measurement configuration indicates to measure one or more second frequency layers different than the first frequency layer based at least in part on the measurement of the first frequency layer failing to satisfy a second bound value.

8. The UE of claim 1, wherein:
the at least one threshold comprises a first threshold and a second threshold that define a range of values, and
the one or more inter-frequency measurements of the second frequency layer are performed based at least in part on the measurement of the first frequency layer being within the range of values.

9. The UE of claim 1, wherein the one or more messages are communicated as part of the cell reselection procedure based at least in part on at least one of the one or more inter-frequency measurements of the second frequency layer satisfying a cell reselection procedure threshold.

10. The UE of claim 1, wherein:
the frequency layer measurement configuration indicates location information associated with a coverage area of the second frequency layer, and
the one or more inter-frequency measurements of the second frequency layer are performed based at least in part on the UE being located within the coverage area.

11. The UE of claim 10, wherein the location information indicates that the coverage area of the second frequency layer is co-located with a coverage area of the first frequency layer.

12. The UE of claim 10, wherein the location information indicates a threshold distance between the coverage area of the second frequency layer and a coverage area of the first frequency layer.

13. The UE of claim 1, wherein the one or more inter-frequency measurements comprise a reference signal received power, a reference signal received quality, or both.

14. The UE of claim 1, wherein the measurement of the first frequency layer comprises a reference signal received power, a reference signal received quality, or both.

15. The UE of claim 1, wherein, to receive the control signaling, the one or more processors are individually or collectively further operable to execute the code to cause the UE to:
receive a system information block or a radio resource control (RRC) message indicating the frequency layer measurement configuration.

16. The UE of claim 1, wherein the first frequency layer is associated with a serving cell for the UE or a non-serving cell for the UE.

17. A network entity, comprising:
one or more memories storing processor-executable code; and
one or more processors coupled with the one or more memories and individually or collectively operable to execute the code to cause the network entity to:
output control signaling that indicates a frequency layer measurement configuration of the network entity, wherein the frequency layer measurement configuration indicates at least one threshold associated with a first frequency layer for triggering measurement of a second frequency layer that is of higher priority than the first frequency layer; and
communicate one or more messages as part of a cell reselection procedure associated with the second frequency layer based at least in part on the control signaling.

18. The network entity of claim 17, wherein, to output the control signaling, the one or more processors are individually or collectively further operable to execute the code to cause the network entity to:
output the control signaling indicating the frequency layer measurement configuration that identifies a plurality of thresholds associated with a plurality of priorities for a plurality of frequency layers.

19. The network entity of claim 17, wherein the control signaling indicates a plurality of frequency layer measurement configurations associated with a plurality of frequency layers, wherein the frequency layer measurement configuration is associated with the first frequency layer.

20. A method for wireless communications at a user equipment (UE), comprising:
receiving control signaling that indicates a frequency layer measurement configuration of a network entity, wherein the frequency layer measurement configuration indicates at least one threshold associated with a first frequency layer for triggering measurement of a second frequency layer that is of higher priority than the first frequency layer;
performing, based at least in part on a measurement of the first frequency layer satisfying the at least one threshold, one or more inter-frequency measurements of the second frequency layer; and
communicating one or more messages as part of a cell reselection procedure associated with the second frequency layer based at least in part on the one or more inter-frequency measurements.
